(19) United States
(12) Patent Application Publication
(10) Pub. No.: US 2013/0177894 A1
(43) Pub. Date: Jul. 11, 2013

(54) SYSTEMS AND METHODS FOR RELATIVE PEER REVIEW

(71) Applicants: Anthony Frank FOTENOS, Baltimore, MD (US); Nabile SAFDAR, Washington, DC (US)

(72) Inventors: Anthony Frank FOTENOS, Baltimore, MD (US); Nabile SAFDAR, Washington, DC (US)

(21) Appl. No.: 13/666,216

(22) Filed: Nov. 1, 2012

Related U.S. Application Data
(60) Provisional application No. 61/583,411, filed on Jan. 5, 2012.

(51) Int. Cl. G09B 7/00

(52) U.S. Cl. 434/353

(57) ABSTRACT

Methods and computer-based products are described for standardized, controlled, peer review of responses to defined material. A logic application for standardizing the defined material, a database for storing information, a program component, and a user interface are described. The user interface is adapted to display standardized material to a user and allow that user to construct a response to the material. The program component is adapted to select at random a pre-defined number of peer responses to the same standardized material to be simultaneously displayed to the user along with the user's response. The user is then allowed to judge all of the responses in reference to one another, and possibly an externally provided reference. The program component is adapted to determine the frequency of responses solicited, limit the display of peer responses, and quantify the user's evaluation to produce feedback related to the relative quality of responses reviewed.

### RELATED APPLICATIONS

This application claims the benefit of U.S. Provisional Patent Application No. 61/583,411, filed on Jan. 5, 2012, the entire contents of which are incorporated by reference herein.

### BACKGROUND

Different individuals rarely provide identical free responses to the same question. How to rate or aggregate free response variation poses an information processing problem. A common strategy for solving this problem is to restrict response variation by constructing multiple-choice questions amenable to automated evaluation. An alternative strategy involves the use of human judges. An advantage of human judgment is that responses can reflect the creative or constructive output of respondents, not question authors, a key limitation of multiple-choice methods.

A limitation of evaluation methods based on human judgment, however, is the potential for human bias. Peer review encompasses a set of methods for human judgment in which respondents and reviewers belong to the same group. Peer review methods generally minimize limitations that may arise when judges belong to non-peer groups less capable of communicating with respondents. Peer review is thus used for evaluation in many academic and professional fields, where responses to questions, cases, or other standardized material involve both some level of expertise and a creative or constructive element.

Though peer review minimizes group-level confounds compared to non-peer methods of human judgment, differences between reviewers and respondents persist within available peer review methods that limit their potential utility. These confounding factors include unmeasured bias that may arise when reviewers judge responses relative to their own implicit opinions and understanding of review standards; hindsight bias that may arise when reviewers judge responses with the benefit of more information than respondents; framing bias that may arise when reviewers judge partially scored responses; attentional bias that may arise when reviewers judge too many responses; personal bias that may arise when reviewers judge responses unblinded to the identity of respondents; and motivational bias that may arise when reviewers operate under a different set of incentives than respondents.

Others have attempted to address some of these problems with peer review. In one known method for conducting peer review, a paper is accepted for peer review, the review assignment is defined and the paper is assigned to reviewers. The reviewers are provided criteria for reviewing the paper and independently provide electronic feedback. All of the peer review results are processed to produce a report. While the method effectively distributes papers to reviewers for review electronically, it does not produce any summative qualitative (for example, a consensus paper) or quantitative (for example, grades for each respondent) output, a key limitation. In addition, the method does not address several potential problems discussed above. For example, peer reviewers are provided only with general evaluation criteria, leaving specific reference standards undefined and individual's judgments therefore poorly controlled.

Another method involves the use of dynamic preference ballots for ranking contest entries. The method displays sequential subsets of entries from a plurality of entries for a user to vote on. A first preference ballot of displayed entries is generated based on selections by the user and the entries are ranked based upon the first user's preference ballot and a second preference ballot from another user. The ranking is determined based on the first and second preference ballots by a Condorcet algorithm. While the general concept describes a relative ranking system, the methods described are not related to review of constructed peer responses to defined material. More specifically, the system requires the user to make a selection of their preferences from among a plurality of displayed alternatives, with no specification for how alternatives are constructed, much less constructed independently in response to defined material or de-identified to minimize bias in evaluation. A system is needed in which a user's independent and free response can be evaluated in the context of peer responses in a consistent and unbiased manner.

### SUMMARY OF THE INVENTION

The present invention relates to a computer program product for standardized, randomized, and internally controlled peer review of responses to defined material. The product includes a logic application enabled to standardize defined material and a user interface operably connected to the logic application. The user interface accepts defined material for peer review, displays the standardized material to a user who provides a first response to the standardized material, accepts the first response, and then simultaneously displays a pre-defined number of peer responses along with the first response to the user. The peer responses are de-identified to the first user, and based upon the standardized material. The product then allows the user to evaluate the first response and peer responses with reference to each other to produce relative evaluation information. The product includes a database operably connected to the user interface, which is enabled to store information and a program component operably connected to the database. The program component randomly selects a plurality of responses to be simultaneously displayed to a user from the database based on pre-defined criteria, determines the frequency of the responses solicited, limits the display of peer responses to a pre-defined number of responses, and quantifies the user entered evaluation information to produce feedback.

In another embodiment, the invention is a method for standardized, randomized, and internally controlled peer review that includes receiving defined material from a database, converting the defined material to standardized material, selecting the standardized material based on pre-defined logic, displaying the standardized material to a user and accepting a first response to the standardized material from the user. Once the first response is received, a pre-defined number of peer responses to the standardized material are displayed to the user simultaneously with the first response. The method enables the user to evaluate the responses with reference to one another to produce relative evaluation information and converts the evaluation information to a numerical score.

In yet another, more specific embodiment of the invention, a computer-based product for standardized, randomized, internally controlled digital image review includes a logic application enabled to generate and assign manufactured textual metadata to an original digital image and remove other identifying information related to the original digital image to produce a standardized digital image. A user interface operably connected to the logic application is included that accepts the original digital image, and displays the standardized digital image to a user. A first response interpreting the standardized digital image is accepted from the user. Then, a reference response is displayed to the user, simultaneously with a pre-defined number of peer responses and the first response. The method allows the user to evaluate the first response and the peer responses simultaneously to produce relative evaluation information. A database is operably connected to the user interface. A program component operable connected to the database, logic application, and the user interface is also included. The program component is enabled, based on pre-defined criteria, to select the digital image to be displayed, randomly select a pre-defined number of peer responses to be simultaneously displayed to the user, determine the frequency of responses solicited, limit the display of peer responses, and convert the evaluation information to a numerical score.

The various aspects and examples of the present inventions are more specifically described with references to the drawings below and with reference to the detailed description of the invention that follows.

### BRIEF DESCRIPTION OF THE DRAWINGS

FIG. 1 is a flow chart illustrative of one embodiment of the method of the invention;

FIGS. 2A-2E illustrate exemplary screen shots displayed to a user while using one embodiment of the invention.

### DETAILED DESCRIPTION

The following description is presented to enable a person of ordinary skill in the art to make and use the invention without undue experimentation. The present invention is a structured method and computer program product for efficiently providing feedback on the relative quality of a user's response to standardized material with reference to a multitude of comparable peer responses. The product can be used for decentralized decision-making or for evaluation and educational purposes. The product of the invention includes four basic components, including a logic application, user interface, database, and program component, adapted to present material in a consistent manner to a group of peers for review. According to the invention, a user evaluates defined material free of any influence from other responses. Then, the user's response is displayed along with responses from peers to the same material.

Embodiments of the invention are based on the concept of relative peer evaluation. Relative evaluation ensures that the system's summative outputs are internally controlled, specifically increasing the likelihood that a reviewer's evaluation is associated with known differences in the responses under review, rather than a reviewer's otherwise implicit free response and generally unknown experiences, standards, motivations, and personal biases. In addition, with respect to educational purposes for peer review, relative evaluation ensures that peers can learn from multiple, comparable, and specific examples of each other's work.

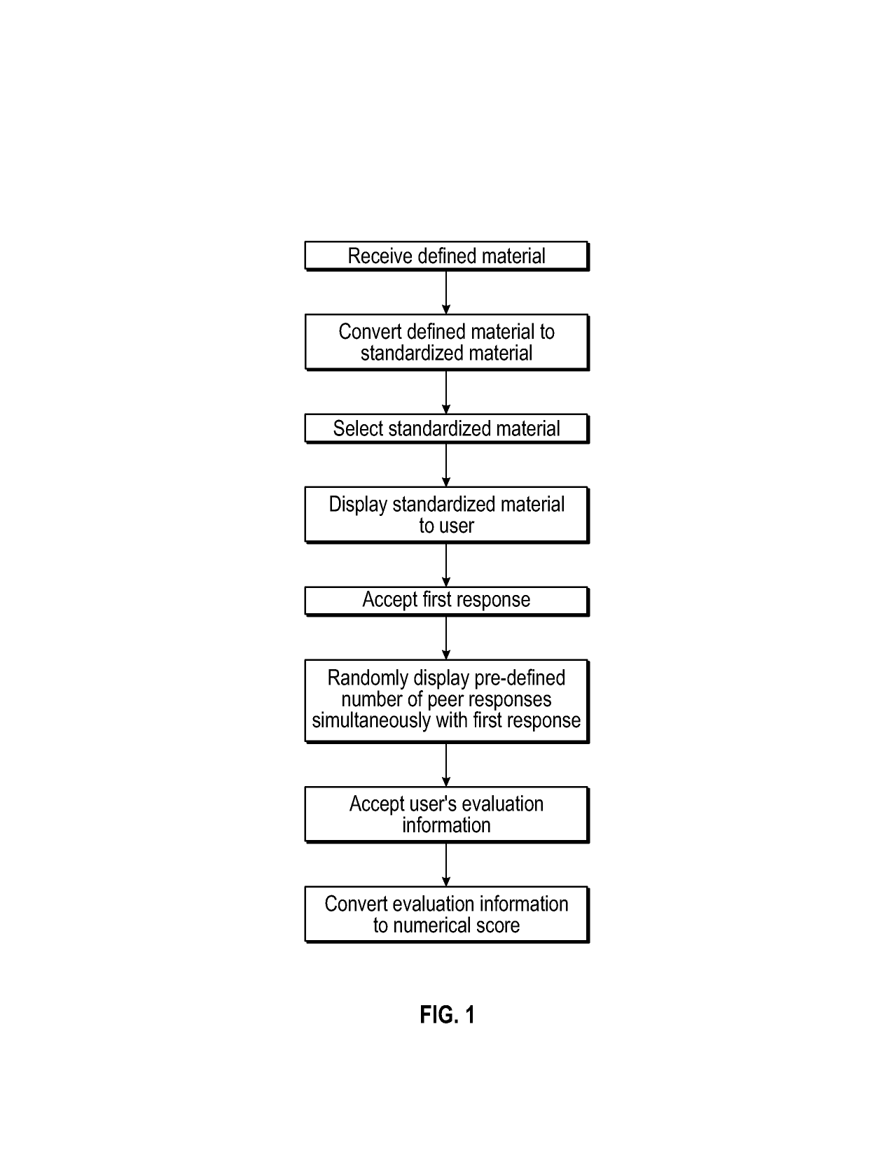

With reference to FIG. 1, and in one embodiment of the invention, a method for standardized, randomized, and internally controlled peer review comprises receiving defined material from a database, converting the defined material to standardized material, and selecting that standardized material for scoring based on pre-defined logic or criteria. The standardized material is displayed to a user, who is able to provide a first response to the standardized material. Upon receiving and accepting the first response, a pre-defined number of peer responses are randomly displayed to the user simultaneously with the first response. The user is enabled to evaluate the first response and peer responses with reference to one another to produce relative evaluation information, which is converted to feedback in the form of numerical scores.

In one embodiment, the invention is a computer program product for standardized, randomized, internally controlled peer review of responses to defined material. The defined material may be any material prompting the construction of variable individual responses. Examples include, but are not limited to, individual cases requiring professional consultation, including diagnostic cases mediated by recorded information such as digital diagnostic images; homework assignments; prompts for audience responses; items for educational testing; solicitations for product or service reviews; requests for proposals or papers; rule sets for judge-based competitions; and future prediction problems. To minimize bias, the invention comprises a logic application enabled to standardize the defined material to produce standardized material.

As used herein, the term “standardize” means to alter the defined material so that it is presented to all users in the same manner. The logic application ensures that all users construct their own responses independently. This feature of the invention is particularly important because it eliminates many problems in available systems for peer review wherein information related to the material under review, including derivative review information, may accumulate with respect to unstandardized material and influence later over earlier reviews. In specific embodiments of the invention, standardization of the defined material comprises generating and assigning manufactured textual metadata to the defined material and removing other identifying information from that material such as patient health information.

As such, and in an even more specific embodiment of the invention, the logic application is enabled to generate and assign manufactured textual metadata to an original digital image and remove other identifying information. Identifying information includes, but is not limited to first name, middle initial, last name, date of birth, account number, sex, address, phone number, attending physician, referring physician, study accession number, medical record number, and department number. The resulting standardized material includes none of the identifying information matched to the patient, except for sex, zip code, and year of birth, since healthcare professionals might use these group-level identifiers to inform their professional opinions. The manufactured metadata is fictitious identifying information and might include an illusory name, birth date, reference physician, and medical record number. It should be noted that embodiments of the invention are envisioned wherein manufactured metadata is assigned and identifying information is redacted from the standardized material outside of the medical setting.

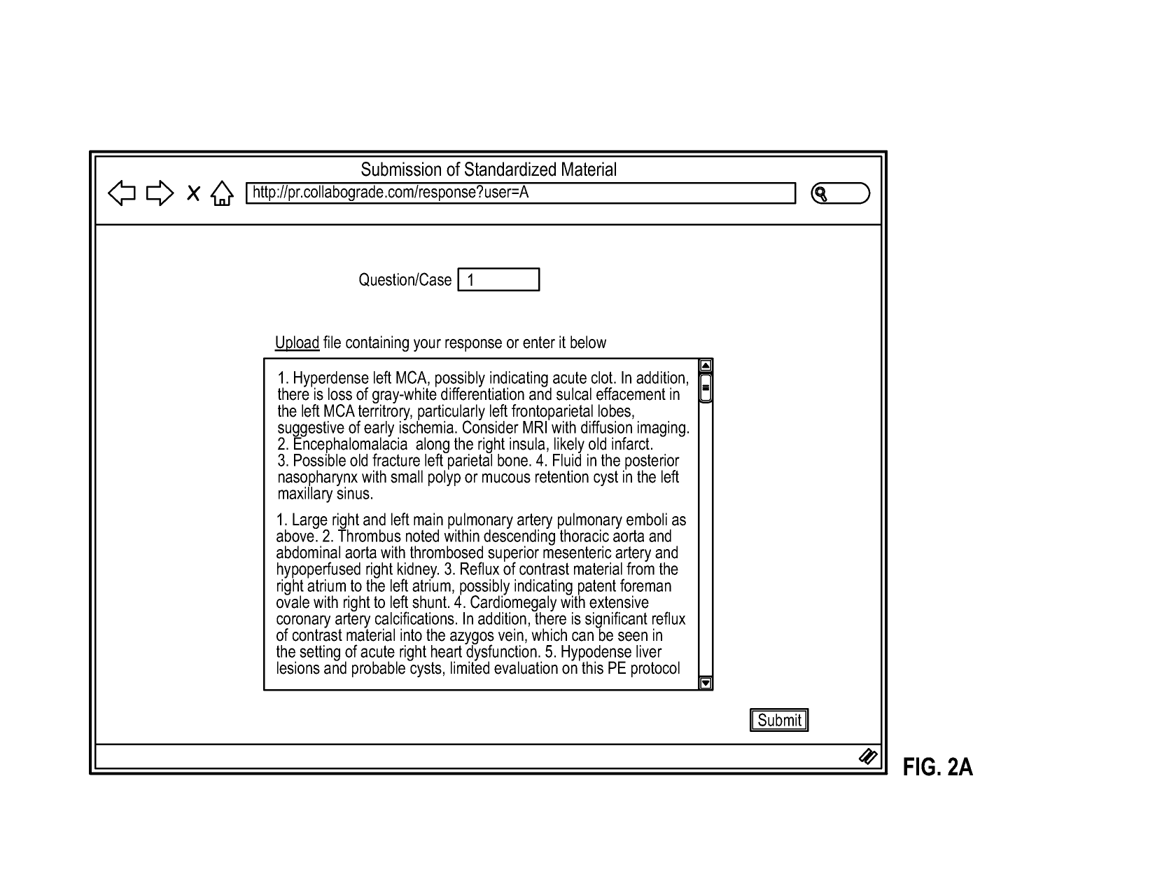

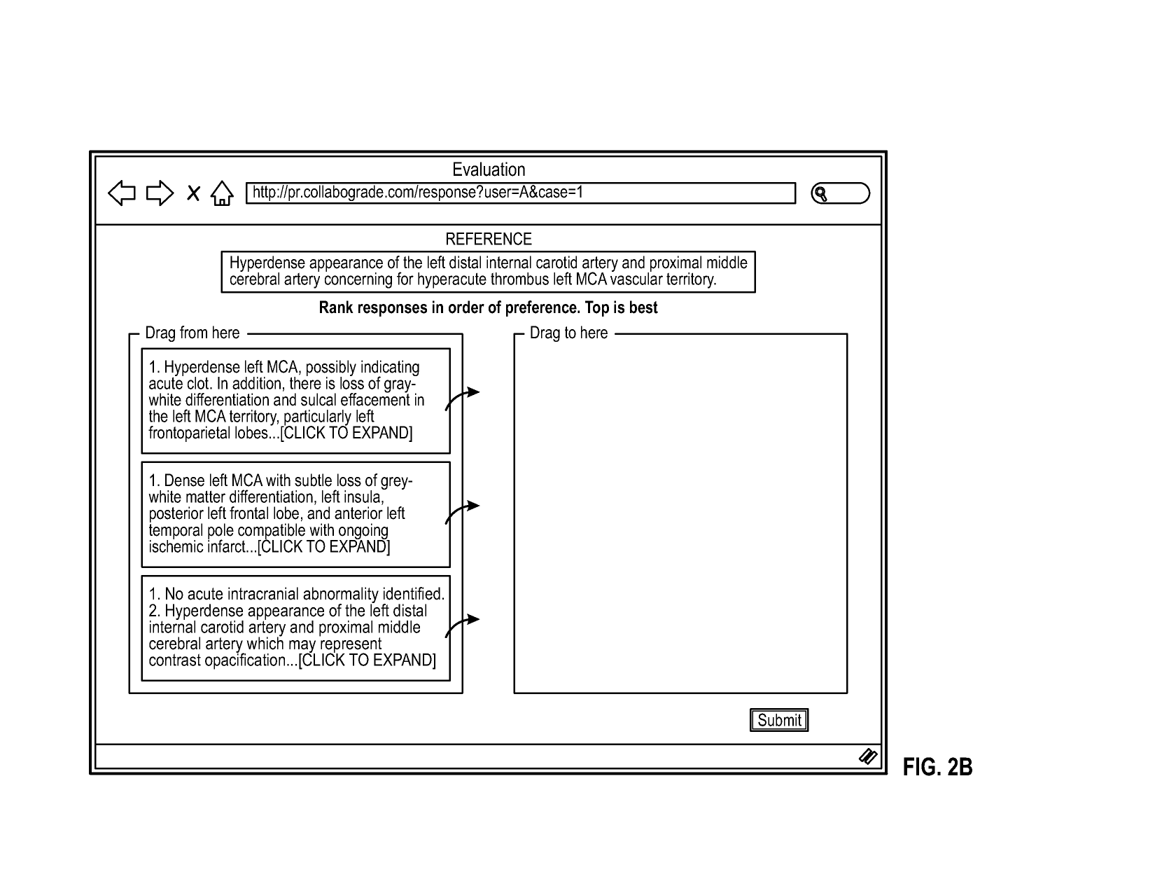

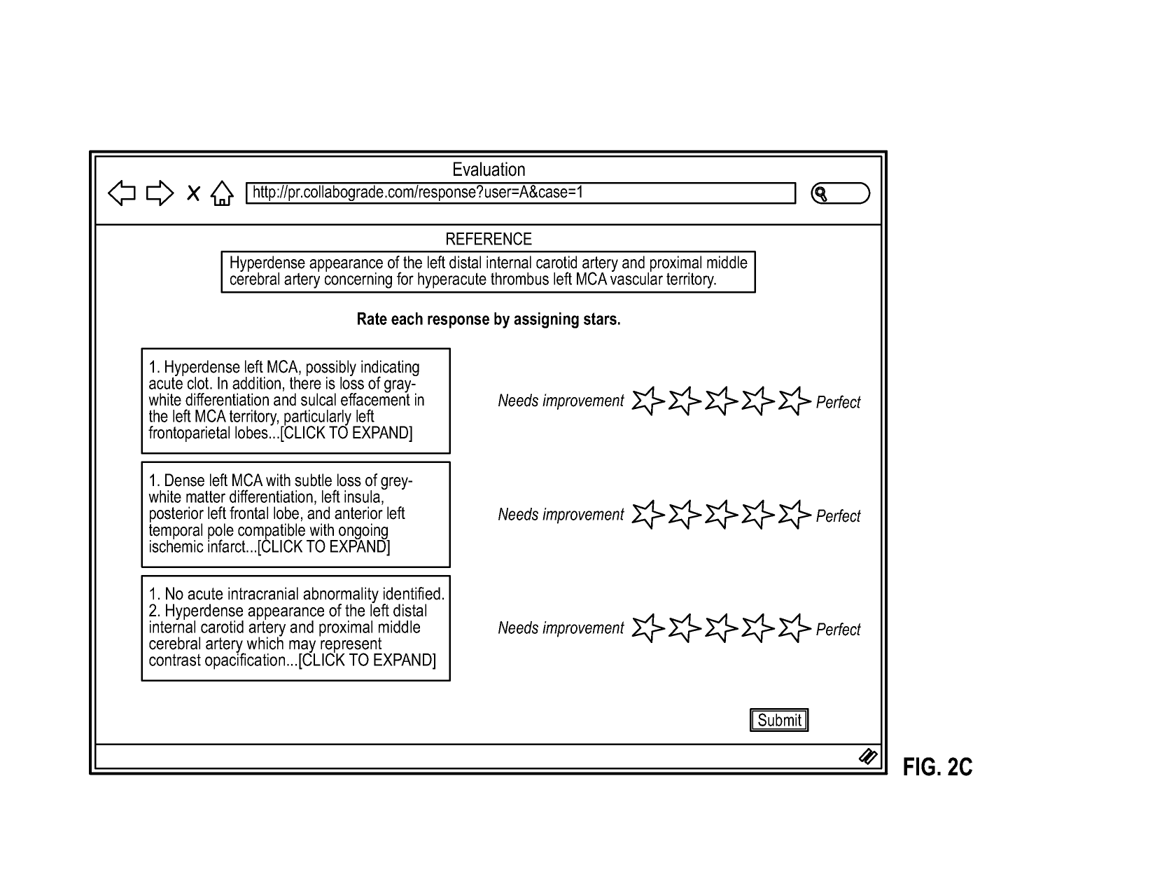

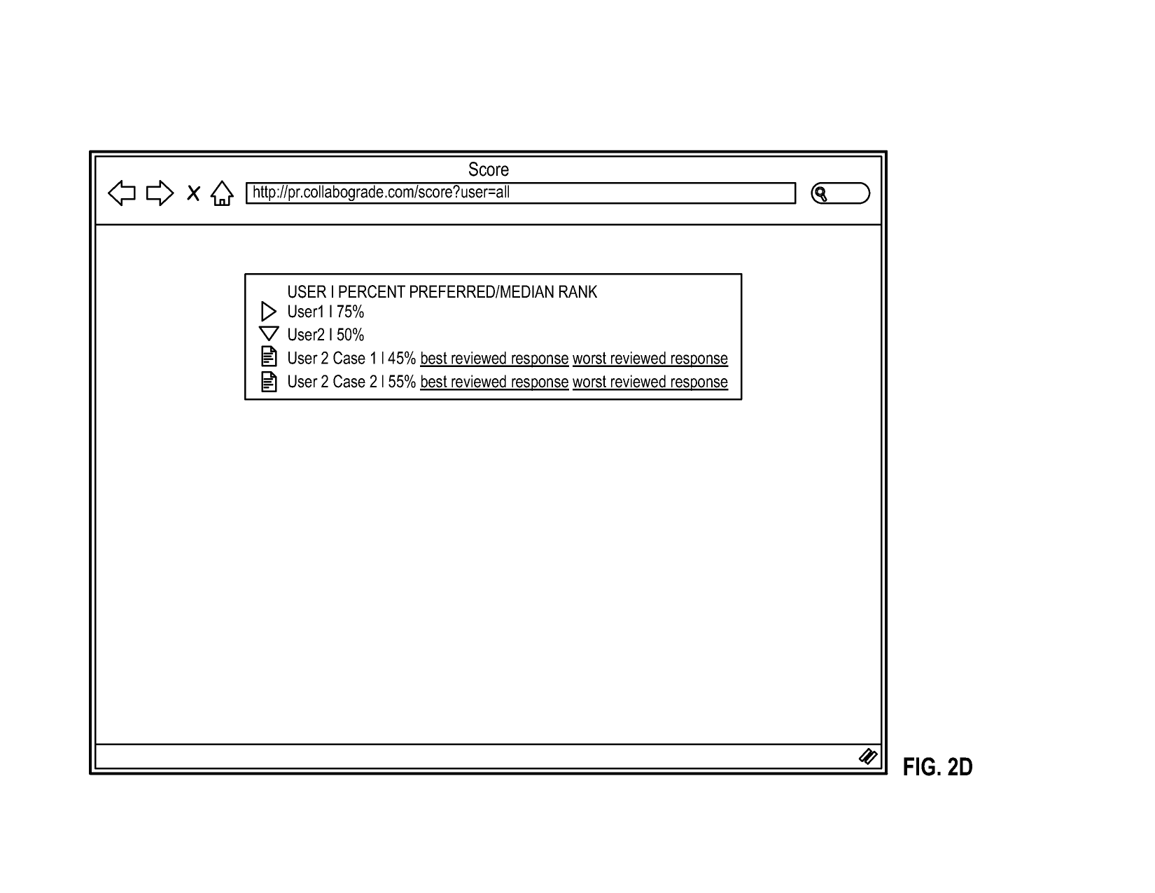

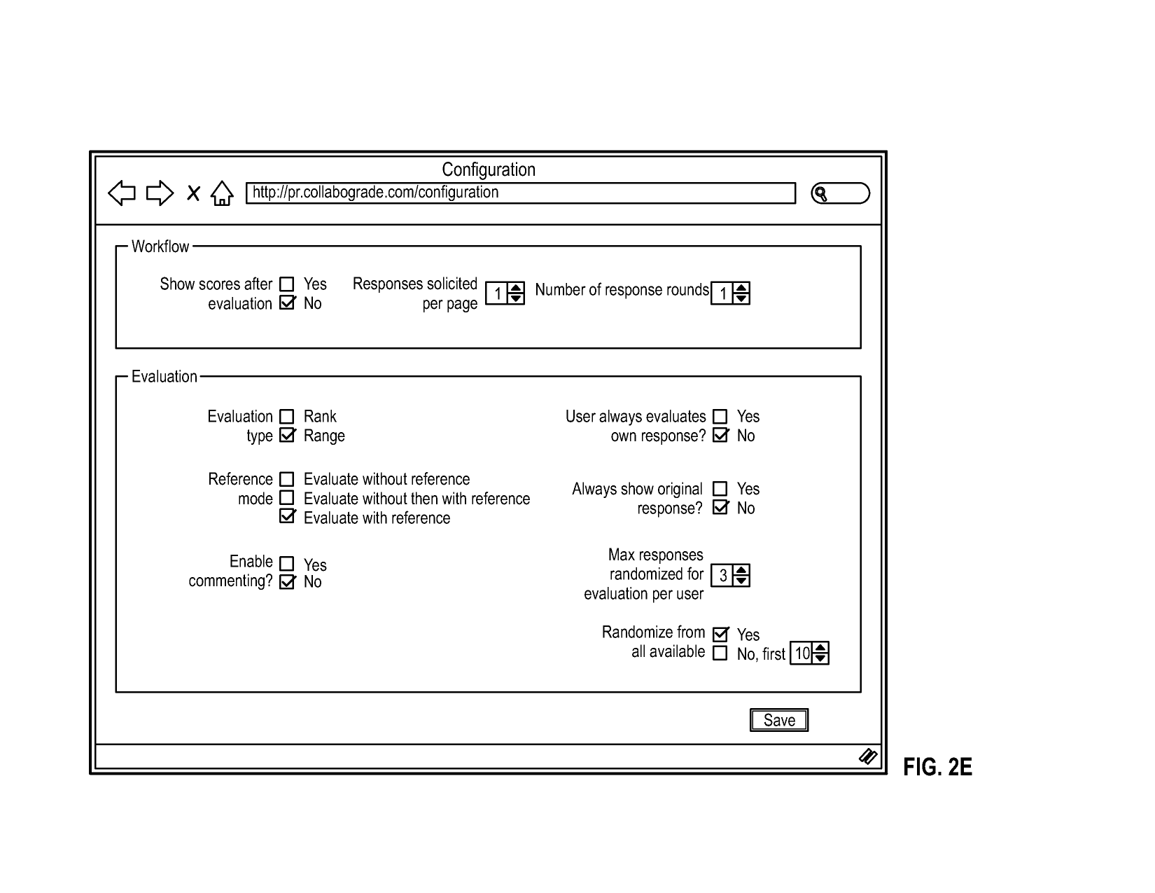

With reference to FIGS. 2A-2E, a user interface is provided to enable communication between the product of the invention and its users. The user interface is adapted to accept the defined material for peer review from a user. The material can be accepted by any known means, including, but not limited to communication with an existing database containing defined material, or by uploading defined material directly from a user or third party.

In accordance with the invention, the user interface is adapted to accept the defined material and transfer it to the logic application for standardization. The defined material is generally assigned a means for identification during storage. In specific embodiments of the invention the means for identification during storage is a case number. The case number is used to coordinate and organize the review process. The user interface then displays the standardized material to a user (not illustrated), who provides a first response to the standardized material. As used herein, the term “response” means an opinion, answer, or interpretation constructed in reaction to the presentation of standardized material. With reference to FIG. 2A, a user enters a first response via the user interface. Any known means for entering the first response into the user interface may be employed, including, but not limited to, uploading the response via the user interface or manually entering the first response into the user interface by keying, or the like.

The first response is accepted via the user interface and saved into a database that is operably connected to the user interface. The database is enabled to store information related to the peer review process. The database is also enabled to be operably connected to other applications containing defined material, including, but not limited to, electronic medical record databases and other electronic reporting applications.

A program component operably connected to the database then randomly selects a pre-defined number of responses from peer reviewers from the database using pre-defined criteria. The program component is enabled to determine the frequency of the response selected for relative review based on the pre-defined criteria. It is also enabled to limit the display to a pre-defined number. In specific embodiments of the invention, the program component limits the display of peer responses to three.

With reference to FIG. 2B, the user interface displays the first response rendered by the user simultaneously with the randomly selected peer responses to the standardized material. The peer responses are de-identified to the first user so that the first user remains unaware of the authors of the peer responses. The peer responses are stored in the database along with each first response generated. The user interface then allows the user to evaluate the first response and peer responses with reference to each other to produce relative evaluation information.

Evaluation information is any information reflecting the first reviewer's judgment for one response in the context of other comparable responses from peers. The evaluation information is therefore internally controlled and not limited to a determination of the merits of a response judged in isolation. As used herein, the term “evaluation” includes, but is not limited to, ranking, rating, grading, and scoring, with or without qualitative comments. At a minimum, the evaluation information therefore consists of ordinal quantities that in the aggregate converge on the relative value of each reviewed response, per the judgment of the peer group, as peer review events accumulate over time.

In another embodiment of the invention (not illustrated), the user interface accepts the user's first response, which is stored in the database for future use as a peer response, but does not solicit an evaluation of that user's first response with reference to peer responses. In particular, in this embodiment, the user enters the first response and then evaluates only non-self peer responses.

In accordance with the invention, the user interface allows the user to evaluate the first and peer responses only with reference to each other to provide evaluation information. In an alternative embodiment of the invention, the user interface is adapted to display a reference response. A reference response is one generally accepted as the standard. Where the defined material is a question with one correct answer, the reference response is the correct answer. Where the defined material is a radiographic digital image, the reference response contains the patient's diagnostic outcome. With reference to FIG. 2E, the reference response is stored in the database of the invention and may be retrieved by the program component and displayed based on pre-defined criteria entered by a user.

Again, with reference to FIG. 2E, the pre-defined criteria may be any peer review criteria desired by a user including, but not limited to, the score display, number of responses solicited, evaluation method, reference preference, original response preference, quantitative comment preference, or combinations thereof. The pre-defined criteria drive logic within the program component, resulting in automated execution of the desired peer review process.

In more specific alternative embodiments of the invention illustrated in FIGS. 2B and 2C, the reference response is displayed prior to the user evaluation. In those embodiments of the invention, the user is able to evaluate the first and peer responses with reference to each other, as well as the reference response. The reference response acts as a guide. This embodiment of the invention increases the likelihood that the peer review evaluations are valid according to an external reference standard with material for which external reference standards are available.

In specific embodiments of the invention illustrated in FIG. 2B, ranking is used to evaluate responses to the standardized material. In that embodiment of the invention, the user reviews the first response as well as peer responses simultaneously. The user then ranks the responses relative to one another. In specific embodiments, the user drags the response from a first box to a second box on the screen in order of preference thereby producing rankings.

In a further specific embodiment of the invention illustrated in FIG. 2C, a range evaluation method is employed whereby the user assigns an ordinal quantity to each of the responses. The ordinal quantity could be numbers, letter grades, stars (illustrated), or any other method for providing a bounded quantifiable judgment.

With reference to FIG. 2D, the program component is adapted to quantify the user-entered evaluation information to produce feedback, which is displayed on demand via the user interface. With reference to FIG. 2E, the product of the invention may be adapted to display feedback instantly to any user, or display of the feedback may be restricted in any desired manner. In accordance with the various embodiments of the invention, the feedback represents the transformation of free and independent responses from individual peers into quantitative output that reflects the peer group's true value determination.

Any known method for quantification may be used to aggregate the user-entered evaluation information. In specific embodiments of the invention, the program component is enabled to quantify the evaluation information based on at least one of Condorcet methodology or majority judgment algorithm.

In accordance with the invention, a user may define the feedback generated by the program component by entering the feedback parameters via the user interface. With reference to FIG. 2D, and in certain embodiments of the invention, the feedback is at least one of a response-level and respondent-level score.

Again, with reference to FIG. 2D, and in certain embodiments of the invention, the feedback includes qualitative evaluation information entered by users. The qualitative evaluation information is solicited by the user interface and transferred to the database, which stores them for later use. Examples of qualitative evaluation information include comments entered by users. The program component may be adapted to display all of the qualitative information entered by users or specific information, for example, the information associated with best and worst evaluations.

The quantification method and type of feedback generated by the program component itself is based on the peer review criteria entered via the user interface. With reference to FIG. 2E, pre-defined, user-entered criteria is used to control the program component of the invention. Any pre-defined peer review criteria may be entered via the user interface, including, but not limited to, whether to display the feedback or evaluation information to a user immediately after evaluation. The criteria are also used to limit the number of responses and evaluations solicited. In specific embodiments of the invention, the program component is adapted to solicit evaluations of a response over multiple rounds designed to approach a consensus response. In certain embodiments of the invention, a user might also define the type of evaluation, use of a reference, and solicitation of qualitative comments. The randomization of the peer responses may also be controlled using pre-defined criteria in accordance with certain embodiments of the invention.

In an alternative embodiment of the invention, a computer-based product for standardized, randomized, and internally controlled peer review of digital images is provided, consisting of a logic application for generating and assigning manufactured textual metadata to an original digital image, which is a radiographic digital image in more specific alternative embodiments. Known identifying information related to the original digital image is removed to produce a standardized digital image. A user interface is connected to the logic application and is adapted to accept the original digital image, but display only the standardized digital image to the user. In other words, the user only sees the image and the manufactured metadata. The user interface is adapted to accept the first response to the standardized digital image from the user. In certain specific embodiments of the invention, the first response is a diagnostic imaging report. Thereafter, the user interface is adapted to display a pre-defined number of peer responses simultaneously with the first response. Both the first response and the peer responses refer to the standardized digital image. The user is unaware of the identifying information that has been removed from the image, as well as information identifying authors of the peer responses. The user interface then allows the user to evaluate the first response and peer responses to produce relative evaluation information.

A program component operably connected to the user interface is included. The program component is enabled both for randomized selection of standardized images for response solicitation and randomized selection of a pre-defined number of peer responses for simultaneous user display. The program component also determines the frequency of responses solicited, limits the display of peer responses, and converts the evaluation information to numerical feedback based on pre-defined criteria.

A database is connected to the user interface and program component to store information related to the digital image review.

What is claimed is:

1. A computer program product for standardized, randomized, and internally controlled peer review of responses to defined material, the product comprising:
a. a logic application enabled to standardize defined material to produce standardized material;
b. a user interface operably connected to the logic application, the user interface enabled to
i. accept defined material for peer review;
ii. display the standardized material to a user who provides a first response related to the standardized material,
iii. accept the first response,
iv. simultaneously display a pre-defined number of peer responses and the first response to the user, the peer responses being de-identified to the first user, and the peer responses based upon the standardized material;
v. allow the user to evaluate the first response and peer responses with reference to each other to produce relative evaluation information; and
vi. display feedback on demand;
c. a database operably connected to the user interface, the database enabled to store information;
d. a program component operably connected to the database, based on pre-defined criteria, the program component enabled to
i. randomly select a plurality of responses to be simultaneously displayed to a user from the database;
ii. determine the frequency of the responses solicited;
iii. limit the display of peer responses; and
iv. quantify the user entered evaluation information to produce feedback.

2. The product of claim 1 wherein the program component is enabled to quantify the evaluation information based on at least one of Condorcet methodology or majority judgment algorithm.

3. The product of claim 2 wherein the program is enabled to create at least one of a response-level score and respondent-level score.

4. The product of claim 1 wherein the user interface is enabled to accept qualitative comments from a peer user and the database is enabled to store the comments with the feedback.

5. The product of claim 1 wherein the program component is enabled to limit the number of peer responses to be displayed to three.

6. The product of claim 1 wherein the program component is adapted to determine the number of rounds over which peer responses are solicited based on pre-defined criteria directed to reaching a consensus response.

7. The product of claim 1 wherein the user interface is enabled to display a reference response stored in the database, the reference response being related to the standardized material, and allow the display to occur before or after the first user evaluation.

8. The product of claim 1 wherein the pre-defined criteria is at least one of score display, number of response solicited, evaluation method, reference preference, original response preference, qualitative comment preference, or combinations thereof.

9. The product of claim 1 wherein the standardized material is at least one of a case requiring professional consultation, including cases mediated by recorded information; homework assignment; prompt for audience responses; item for educational testing; solicitation for product or service review; request for proposal or paper; rule set for judge-based competition; and prediction problem.

10. The product of claim 9 wherein the standardized material is a digital diagnostic image.

11. The product of claim 10 wherein the standardization comprises producing manufactured metadata, associating the metadata with the defined material, and removing other identifying information from the defined material.

12. A method for standardized, randomized, and internally controlled peer review of responses to defined material comprising:
receiving defined material from a database;
converting the defined material to standardized material;
selecting standardized material to be scored based on pre-defined logic;
displaying the standardized material to a user and accepting a first response of the standardized material from the user;
responsive to receiving the first response, randomly displaying a pre-defined number of peer responses related to the standardized material to the user simultaneously with the first response;
enabling the user to evaluate the first response and peer responses with reference to one another to produce relative evaluation information; and
converting the evaluation information to a numerical score.

13. The method of claim 12 wherein the evaluation information based on at least one of Condorcet methodology or majority judgment algorithm.

14. The method of claim 12 wherein the numerical score is at least one of a response-level score and respondent-level score.

15. The method of claim 12 further comprising accepting and simultaneously displaying qualitative comments from a peer user along with the first response and peer responses.

16. The method of claim 12 wherein the selection of standardized material is based on logic directed to reaching a consensus response.

17. The method of claim 12 further comprising displaying a reference response before or after the user evaluates at least one of the first response and peer responses.

18. The method of claim 12 wherein the defined criteria is at least one of a digital image or homework assignment, professional opinion, prompt, question, medical opinion, solicitation, presentation, academic paper, audience response, exam, quiz item, exam item response, or professional consultation.

19. The product of claim 12 wherein the converting the defined material to standardized material comprises associating manufactured metadata to defined material and removing other identifying information from the defined material.

20. A computer-based product for standardized, randomized, and internally controlled digital image review, the product comprising:
a. a logic application enabled to generate and assign manufactured textual metadata to an original digital image and remove known identifying information related to the original digital image to produce a standardized digital image;
b. a user interface operably connected to the logic application, the user interface enabled to
i. accept the original digital image;
ii. display the standardized digital image to a user, the standardized digital image being identifiable solely by the manufactured metadata;
iii. accept a first response to the standardized digital image from the user;
iv. display a reference response to the user;
v. display a pre-defined number of peer responses and the first response to the user simultaneously, the peer responses based on a reviews of the standardized digital image from at least one other peer user; and
vi. allow the user to evaluate the first response and the peer responses to produce relative evaluation information,
c. a database operably connected to the user interface;
d. a program component operable connected to the database, logic application, and the user interface, the program component enabled to randomly select the standardized digital image to be displayed, randomly select a pre-defined number of peer responses to be simultaneously displayed to the user, determine the frequency of responses solicited, limit the display of peer responses and convert the evaluation information to a numerical score, based on pre-defined logic.
